(19) United States
(12) Patent Application Publication
(10) Pub. No.: US 2026/0357376 A1
(43) Pub. Date: Nov. 12, 2026

(54) SUSPENSION SMELTING FURNACE

(71) Applicant: Metso Metals Oy, Espoo (FI)

(72) Inventors: Peter BJÖRKLUND, Espoo (FI); Markku LAHTINEN, Espoo (FI)

(21) Appl. No.: 19/475,233

(22) PCT Filed: Apr. 14, 2023
(86) PCT No.: PCT/FI2023/050211

§ 371 Date: Oct. 14, 2025

(51) Int. Cl. C22B 15/00; C22B 7/04; C22B 23/02

(52) U.S. Cl. CPC C22B 15/0054; C22B 7/04; C22B 15/0047; C22B 23/025

(57) ABSTRACT

The present invention relates to a suspension smelting furnace, comprising a reaction shaft (5), a settler (8), a first taphole (15), a second taphole (17) and feeding means (30) for feeding a molten material (31) to the suspension smelting furnace.

### FIELD OF THE INVENTION

The present invention relates to a suspension smelting furnace. The present invention also relates to a method for using said suspension smelting furnace.

### BACKGROUND OF THE INVENTION

Conventional processes for the conversion of metal containing concentrate typically comprise flash smelting and flash converting.

The process usually involves oxidation of the concentrate in a flash smelting furnace (FSF) to produce matte. The matte may then then be fed to a flash converting furnace (FCF) or a Peirce Smith converter, where the matte is further oxidised. In the process, slag is formed both in the FSF and FCF or Peirce Smith converter. The slag typically comprises a significant amount of metals and should thus be recycled back to one or several furnaces for further processing in order to improve the yield of the process. In one embodiment, the slag from the FCF or Peirce Smith converter should be recycled to the FSF.

The recycling of slag consumes a lot of resources as the slag is typically granulated by water sprays, stored in bins and fed into a dryer before being fed back into the furnaces. The granulation of the slag consumes a lot of water, since water is mainly used to cool down the slag and to break it into smaller particles. This causes steaming losses and particle contamination of the granulation water, which requires further treatment before reuse of the water is possible. When the slag is fed to the furnace to which it is to be recycled, energy is required to heat up the slag again to a temperature sufficient to melt the slag. The slag granulation water needs to be cooled by a secondary cooling water circuit, which further consumes energy and water.

Further, it is important that the recycled slag is mixed well with the reaction mixture in the furnace in order to allow as much exchange of metals from the slag to the product of the furnace.

As such there is a need for improved furnaces and methods that allow recycling of molten material between the furnaces. There is also a need for improved furnaces and methods that allow good mixing of the slag and the product of the furnace.

### SUMMARY

In a first aspect, there is provided a suspension smelting furnace according to the figures, comprising:
i. a reaction shaft (5) provided with a burner for burning concentrate or matte (4) and feeding concentrate or matte (1) into the reaction shaft (5) to form a jet of an at least partially oxidised suspension (6) in the reaction shaft (5),
ii. a settler (8) in communication with a lower end of the reaction shaft (5), wherein the settler (8) has an inner space (9) and a first end wall structure (27) at one end of the settler (8) and a second end wall structure (28) at the opposite end of the settler (8) and a landing zone (7) for the jet of oxidised suspension (6) in the inner space (9) of the settler (8) below the lower end of the reaction shaft (5), and wherein the settler (8) extends in two opposite directions from the landing zone (7) so that the settler (8) comprises a first settler part (18) on a first side of the landing zone (7) and a second settler part (19) on an opposite second side of the landing zone (7), and wherein the settler (8) is configured to receive the at least partially oxidised suspension (6) from the reaction shaft (5) at the landing zone (7) and to form a layer of matte or metal alloy (10) and a layer of slag (11) on top of the layer of matte or metal alloy (10) in the inner space (9) of the settler (8),
iii. a first taphole (15) arranged in the second settler part (19) for discharging slag (14) from the layer of slag (11) in the inner space (9) of the settler (8), and
iv. a second taphole (17) arranged in the second settler part (19) for discharging matte or metal alloy (16) from the layer of matte or metal alloy (10) in the inner space (9) of the settler (8),
wherein the first taphole (15) is arranged in the vertical direction at a level above the second taphole (17), and wherein the suspension smelting furnace further comprises
v. feeding means (30) for feeding a molten material (31) to the suspension smelting furnace, wherein the feeding means (30) is in communication with the settler (8) in the first settler part (18) above the layer of slag (11) when in use.

According to a second aspect a method for producing matte or metal alloy in a suspension smelting furnace is provided, comprising:
i. feeding concentrate or matte (1) by means of a burner for burning concentrate or matte (4) into a reaction shaft (5) of the suspension smelting furnace to form a jet of an at least partially oxidised suspension (6) in the reaction shaft (5),
ii. receiving the jet of an at least partially oxidised suspension (6) in a landing zone (7) of a settler (8) in communication with a lower end of the reaction shaft (5), wherein the settler (8) has an inner space (9) and a first end wall structure (27) at one end of the settler (8) and a second end wall structure (28) at the opposite end of the settler (8), and wherein the settler (8) extends in two opposite directions from the landing zone (7) so that the settler (8) comprises a first settler part (18) on a first side of the landing zone (7) and a second settler part (19) on an opposite second side of the landing zone (7),
iii. forming a layer of matte or metal alloy (10) and a layer of slag (11) on top of the layer of matte or metal alloy (10) in the inner space (9) of the settler (8),
iv. discharging slag (14) from the layer of slag (11) in the settler (8) through a first taphole (15) arranged in the second settler part (19), and
v. discharging the matte or metal alloy (16) from the layer of matte or metal alloy (10) in the settler (8) through a second taphole (17) arranged in the second settler part (19),
wherein the first taphole (15) is arranged in the vertical direction at a level above the second taphole (17), and wherein the method further comprises
vi. feeding a molten material (31) into the suspension smelting furnace through feeding means (30), wherein the feeding means (30) is in communication with the settler (8) in the first settler part (18) and the molten material (31) is fed to the first settler part (18) above the layer of slag (11).

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a schematic illustration of a suspension smelting furnace according to the first embodiment of the invention, wherein the feeding means (30) is arranged in the first distal end of the first settler part (18) and the first taphole (15) and the second taphole (17) are arranged in the second distal end of the second settler part (19).

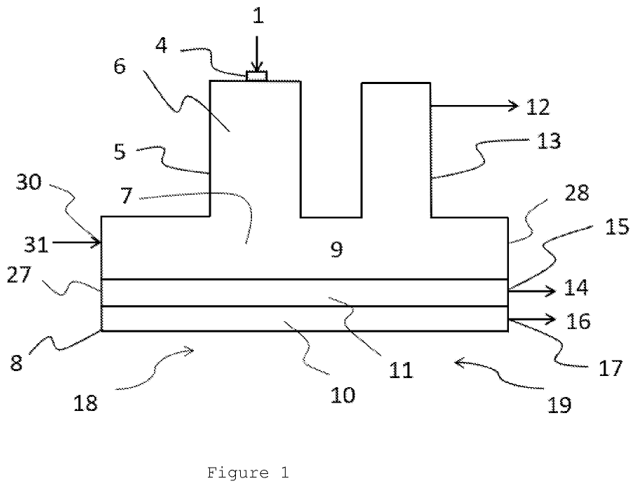

FIG. 2 is a schematic illustration of a suspension smelting furnace according to the first embodiment of the invention, wherein the feeding means (30) is arranged in the roof of the settler in the first settler part (18) and the first taphole (15) and the second taphole (17) are arranged in the second distal end of the second settler part (19).

FIG. 3 is a schematic illustration of a suspension smelting furnace according to the first embodiment of the invention, wherein the feeding means (30) is arranged in the side wall of the settler in the first settler part (18) and the first taphole (15) and the second taphole (17) are arranged in the second distal end of the second settler part (19).

FIG. 4 is a schematic illustration of a suspension smelting furnace according to the first embodiment of the invention, wherein the feeding means (30) is arranged in the first distal end of the first settler part (18) and the first taphole (15) is arranged in the second distal end of the second settler part (19) and the second taphole (17) is arranges in the side wall of the second settler part (19).

FIG. 5 is a schematic illustration of a suspension smelting furnace according to the first embodiment of the invention, wherein the feeding means (30) is arranged in the first distal end of the first settler part (18) and the second taphole (17) is arranged in the second distal end of the second settler part (19) and the first taphole (15) is arranges in the side wall of the second settler part (19).

### DETAILED DESCRIPTION

It is obvious to a person skilled in the art that with the advancement of technology, the basic idea of the invention may be implemented in various ways. The invention and its embodiments are thus not limited to the examples described below, instead they may vary within the scope of the claims.

### Suspension Smelting Furnace

In a first aspect, there is provided a suspension smelting furnace according to the figures, comprising:
i. a reaction shaft (5) provided with a burner for burning concentrate or matte (4) and feeding concentrate or matte (1) into the reaction shaft (5) to form a jet of an at least partially oxidised suspension (6) in the reaction shaft (5),
ii. a settler (8) in communication with a lower end of the reaction shaft (5), wherein the settler (8) has an inner space (9) and a first end wall structure (27) at one end of the settler (8) and a second end wall structure (28) at the opposite end of the settler (8) and a landing zone (7) for the jet of oxidised suspension (6) in the inner space (9) of the settler (8) below the lower end of the reaction shaft (5), and wherein the settler (8) extends in two opposite directions from the landing zone (7) so that the settler (8) comprises a first settler part (18) on a first side of the landing zone (7) and a second settler part (19) on an opposite second side of the landing zone (7), and wherein the settler (8) is configured to receive the at least partially oxidised suspension (6) from the reaction shaft (5) at the landing zone (7) and to form a layer of matte or metal alloy (10) and a layer of slag (11) on top of the layer of matte or metal alloy (10) in the inner space (9) of the settler (8),
iii. a first taphole (15) arranged in the second settler part (19) for discharging slag (14) from the layer of slag (11) in the inner space (9) of the settler (8), and
iv. a second taphole (17) arranged in the second settler part (19) for discharging matte or metal alloy (16) from the layer of matte or metal alloy (10) in the inner space (9) of the settler (8),
wherein the first taphole (15) is arranged in the vertical direction at a level above the second taphole (17), and wherein the suspension smelting furnace further comprises
v. feeding means (30) for feeding a molten material (31) to the suspension smelting furnace, wherein the feeding means (30) is in communication with the settler (8) in the first settler part (18) above the layer of slag (11) when in use.

Prior to feeding the concentrate or matte (1) to the concentrate or matte burner (4), it may be dried to a moisture content of 0 to 1%, preferably in a steam or rotary dryer or a matte grinding mill. This consumes steam or fuel in the form of natural gas or fuel oil.

The burner for burning concentrate or matte (4) may be designed to symmetrically mix the feed and an oxygen enriched gas. The oxygen enriched gas may be air or oxygen-enriched air. In one embodiment, the reaction shaft (5) provides means for delivering natural gas or fuel oil to the reaction shaft fuel burner(s). The natural gas or fuel oil provides additional heat when burned in the reaction shaft (5), which facilitates the melting of the concentrate or matte (1) fed thereto.

The suspension smelting furnace may be a Flash Smelting Furnace (FSF) or a Flash Converting Furnace (FCF). If the suspension smelting furnace is an FSF, concentrate may be fed to the furnace. If the suspension smelting furnace is an FCF matte may be fed to the furnace. However, some low-grade matte may be fed to the FSF for further processing. Similarly, if the suspension smelting furnace is an FSF, the settler (8) may be configured to receive the at least partially oxidised suspension (6) from the reaction shaft (5) at the landing zone (7) and to form a layer of matte (10) and a layer of slag (11) on top of the layer of matte (10) in the inner space (9) of the settler (8). To the contrary, if the suspension smelting furnace is an FCF, the settler (8) may be configured to receive the at least partially oxidised suspension (6) from the reaction shaft (5) at the landing zone (7) and to form a layer of metal alloy (10) and a layer of slag (11) on top of the layer of metal alloy (10) in the inner space (9) of the settler (8).

The jet of the at least partially oxidised suspension may be formed in the burner and guided to the settler through the reaction shaft. The jet of the at least partially oxidised suspension (6) is in one embodiment heated to a temperature sufficient to completely melt the concentrate or matte. The jet of the at least partially oxidised suspension (6) is preferably heated to a temperature of 1100 to 1600 °C, or 1250 to 1450 °C, for example 1300 °C. It has been found that heating the jet of the at least partially oxidised suspension (6) to these temperatures ensures that the suspension (6) is completely melted, and that the viscosity of the slag is suitable for separation of the two phases, i.e. slag and matte or metal alloy.

Concentrate may refer to ore concentrate that is the product of metal ore mines. Specifically, concentrate may comprise copper or nickel concentrate comprising copper and iron or nickel and iron in the form of copper or nickel and iron sulphides. The exact composition of the concentrate may vary depending on the geographical origin of the metal ore. In one embodiment, the concentrate is fed to the reaction shaft in a solid state as fine granules.

If copper concentrate is used, the suspension smelting furnace may be an FSF and/or FCF and the metal alloy may comprise copper blister. In one embodiment, the metal alloy comprises at least 60 wt.-%, or at least 80 wt.-% or 100 wt.-% copper blister.

The copper blister may comprise copper, iron and sulphur. In one embodiment, the copper blister comprises 96 to 99.5 wt.-% copper and 0.01 to 0.5 wt.-% iron.

If nickel concentrate is used, the suspension smelting furnace may be an FSF. The FSF may be used in combination with a Peirce Smith converter to produce high grade nickel matte.

The high grade nickel matte may comprise nickel, iron and sulphur. In one embodiment, the high grade nickel matte comprises 96 to 99.5 wt.-% nickel and 0.01 to 0.5 wt.-% iron.

A conventional Peirce Smith converter is disclosed in Davenport et. al., 2002, Extractive Metallurgy of Copper, ELSEVIER SCIENCE Ltd, ISBN: 0-08-044029-0.

At least partially oxidised may refer to at least 60 wt.-%, 70 wt.-%, 80 wt.-%, 90 wt.-% or 100 wt.-% of the iron present in the furnace feed being in an oxidized state. An oxidized state may refer to the iron elements being in the form of oxidic compounds and the wt.-% may refer to the percentage of the iron present in the furnace feed being in an oxidized state. It is particularly advantageous to form a jet wherein at least 70 wt.-% of the iron is in an oxidized state because this reduces the oxidation requirement, which otherwise would be performed further down the process line.

The slag may comprise copper and iron oxides as well as fluxing agents if copper concentrate has been used and nickel and iron oxides as well as fluxing agents if nickel concentrate has been used. The fluxing agents may be compounds comprising silica and/or calcium. in one embodiment, silicon dioxide is used as fluxing agents when the suspension smelting furnace is an FSF and lime, calcium carbonate or calcium oxide is used as fluxing agents when the suspension smelting furnace is an FCF. The fluxing agents may be fed to the reaction shaft. The fluxing agents decrease the viscosity of the slag which facilitates the discharge of slag from the suspension smelting furnace and minimises the formation of material to be reverted. Preferably the weight ratio of iron to silicon dioxide in the FSF slag is 0.9 to 2.0, or 0.7 to 1.8, for example 1.0 to 1.5. Silicon dioxide, lime, calcium carbonate or calcium oxide is particularly useful as fluxing agents because they are relatively inexpensive while still giving the desired result of lowering the viscosity of the slag.

The term “in communication with” refers to an open space being available between the discussed components such that the components share the open space, and such that material can be freely exchanged between the components.

The settler (8) may further comprise two side walls, a bottom and a roof extending between the first end wall structure (27) and second end wall structure (28). The end wall structures (27, 28) may have the form of a square or rectangle such that the side walls, bottom and roof extend from the peripheries of the first end wall (27) to the peripheries of the second end wall (28), and thereby form a closed space between the end walls (27, 28), bottom, roof and sidewalls. The reaction shaft (5) may be located in the roof and the layer of slag and matte or metal alloy (10,11) may rest on the bottom when the device is in use. The bottom may slope downwardly for example in an inclined and/or curved manner towards the first and second taphole (15, 17) for facilitating the discharge of slag and matte or metal alloy.

In one embodiment, the feeding means (30) for feeding molten material (31) to the suspension smelting furnace comprises a launder or an opening for introducing the molten material (31) continuously or batchwise. Alternatively, the feeding means (30) for feeding molten material (31) to the suspension smelting furnace may comprise a pot or a ladle for feeding the molten material (31) batchwise. The molten material (31) may be fed to the suspension smelting furnace through gravity. This has the added utility that no energy is required for conveying the molten material (31). The temperature of the molten material (31) is preferably between 1000 °C and 1450 °C, or between 1220 °C and 1320 °C, for example 1270 °C. It has been found that these temperatures are high enough to maintain e.g. slag as the molten material in a liquid form but low enough not to damage the equipment used.

The suspension smelting furnace according to the first aspect may comprise an uptake shaft (13) for leading process gases (12) from the suspension smelting furnace via the uptake shaft (13), wherein the uptake shaft (13) has a lower end in communication with the settler (8) in the second settler part (19).

The process gases (12) may comprise sulfur dioxide, carbon dioxide, water, metal containing vapors, nitrogen and some reaction shaft product in the form of unsettled suspension particles. Specifically, the unsettled suspension particles, which are dust, comprise copper or nickel compounds depending on if copper or nickel concentrate has been used in one embodiment.

The process gases (12) may be led to a heat exchanger for cooling the process gases followed by gas and solid separation. The heat exchanger is typically but not necessarily a steam boiler, which cools the gases by evaporating water into steam. Dust may be separated from the gas in the gas and solid separation. The gas and solid separator may be an electrostatic precipitator, which collects and separates the dust from the gases. In one embodiment, the dust is recycled back to the burner (4) of the reaction shaft (5) of the suspension smelting furnace. The heat from the cooling may be recovered and used as electricity.

The dust may be recycled from the uptake shaft (13) of the suspension smelting furnace (an FSF or FCF) via the heat exchanger and solid separation to the burner (4) of the same suspension smelting furnace. Alternatively, the dust may be recycled from the uptake shaft (13) of one suspension smelting furnace, e.g. an FCF, via the heat exchanger and solid separation to the burner (4) of another suspension smelting furnace, e.g. an FSF. Recycling the dust improves the yield of the copper or nickel in the end product as some copper or nickel is still present in the dust. For the avoidance of doubt, the copper yield may be improved if copper concentrate is used, and the nickel yield may be improved if nickel concentrate is used.

The burner (4) according to the first aspect further be suitable for feeding a fluxing agent (1), a reaction gas containing oxygen (1), solidified slag (1), dust and/or material to be reverted (1).

The dust may be recycled and treated as described above. The fluxing agents may be as described above.

The reaction gas containing oxygen facilitates the oxidation of the concentrate/matte in the reaction shaft (5).

Material to be reverted may be fed both to an FSF or an FCF and recycled from the output of the suspension smelting furnace to the input of the same suspension smelting furnace or from another suspension smelting furnace to the input of the suspension smelting furnace.

In one embodiment, solidified slag refers to slag produced in a suspension smelting furnace, which has been discharged via the first taphole and solidified. The slag may be discharged from an FCF and recycled to an FSF if copper concentrate has been used, for example. The slag may be recycled from a Peirce Smith converter to an FSF if nickel concentrate has been used. The slag may also be discharged from the same suspension smelting furnace to which it is recycled regardless of if copper or nickel concentrate has been used. The slag may be solidified and granulated using water and/or air and/or nitrogen prior to being fed to the suspension smelting furnace.

Material to be reverted may refer to any reaction shaft product that has accumulated from the off-gas lines, the launders or ladles and the furnaces. The material to be reverted may be fed to the suspension smelting furnace by mixing it with the main feed or through a separate feeder.

Solidified slag and material to be reverted usually comprise a significant amount of metals and by recycling these to the suspension smelting furnace (the same suspension smelting furnace from which they originate or to another suspension smelting furnace) the remaining metals may be recovered.

Alternatively, no fluxing agents are fed to the burner (4) when the suspension smelting furnace is an FCF and copper concentrate is used. The copper present in the matte may be oxidised to convert a part of the copper into copper oxide. The presence of copper oxide in the slag assists in liquefying the slag. It may be desirable to oxidise the copper to attain at least 30 wt.-% of oxidised copper in the slag of the total weight of the slag. The desired ratio may be achieved by injecting the reaction gas containing oxygen through the burner to achieve a partial pressure (pO2) of from 1 to 100 Pa, or from 2 to 70 Pa, or from 10 to 30 Pa. In one embodiment, the concentration of oxidised copper in the slag is from 30 to 90 wt.-%, or from 35 to 70 wt.-%, or from 40 to 60 wt.-%, of the total weight of the slag. Accordingly, it may be possible to convert copper containing material to blister copper without use of conventional fluxing agents. The desired temperature of the burner may be dependent on the desired concentration of oxidised copper in the converter slag. The temperature is typically at least 1200 °C to ensure that the slag is in a molten phase and to attain acceptable yield of copper. When lower concentration of copper oxide is present in the slag a higher temperature may be required. The temperature is for example from 1220 to 1450 °C, from 1250 to 1400, or from 1300 to 1380 °C.

When fluxing agents and copper concentrate are used, the oxidised copper concentration in the slag of the FCF may be 5 to 30 wt.-%.

The matte according to the first aspect may comprise copper matte and the metal alloy may comprise blister copper or the matte may comprise nickel matte.

The matte according to the first aspect may comprise copper matte or nickel matte, depending on if copper or nickel concentrate has been used. In one embodiment, the matte comprises at least 60 wt.-%, or at least 80 wt.-%, or 100 wt.-%, copper matte or nickel matte.

Matte may refer to the product of an FSF to which concentrate and oxygen has been fed. Specifically, the matte may comprise iron and copper sulphides and the copper content of the matte may be 40 to 75 wt.-%, if copper concentrate has been used. To the contrary, the matte may comprise iron and nickel sulphides and the nickel content of the matte may be 13 to 72 wt.-%, if nickel concentrate has been used.

In one embodiment, the matte is fed to the reaction shaft (5) of an FCF in a solid state as fine granules if copper concentrate has been used. As such, it may be required to cool down and granulate the matte originating from the FSF prior to feeding the matte to the FCF. The matte is usually cooled and granulated by water and/or air and/or nitrogen and crushed into fine granules using a grinding mill. The grinding mill may use natural gas or steam as fuel. In one embodiment, the matte is fed to a Peirce Smith converter in a liquid state if nickel concentrate has been used.

The molten material (31) according to the first aspect may comprise slag, preferably wherein the slag comprises iron and copper oxides and fluxing agents or wherein the slag comprises iron and nickel oxides and fluxing agents.

The molten material (31) may comprise at least 60 wt.-%, or at least 80 wt.-% or 100 wt.-% slag. In one embodiment, the slag comprises iron and copper oxides and fluxing agents, if copper concentrate has been used. The slag may comprise 0.4 to 40 wt.-% copper and 5 to 55 wt.-% iron. In one embodiment, the slag comprises iron and nickel oxides and fluxing agents, if nickel concentrate has been used. The slag may comprise 0.3 to 30 wt.-% nickel and 25 to 60 wt.-% iron.

The slag may be recycled from the suspension smelting furnace slag discharge to the feeding means of the same suspension smelting furnace or to another suspension smelting furnace. For example, an FSF may be used to produce copper matte and the copper matte may be fed to an FCF, then the slag from the FCF may be recycled to the FSF in a molten form, if copper concentrate has been used. For example, an FSF may be used to produce nickel matte and the nickel matte may be fed to a Peirce Smith converter, then the slag from the Peirce Smith converter may be recycled to the FSF in a molten form, if nickel concentrate has been used.

The inventors have surprisingly found that by recycling molten material and particularly slag from one suspension smelting furnace to another suspension smelting furnace or from a Peirce Smith converter to a suspension smelting furnace in a molten form through the feeding means (30) described herein a number of advantages are achieved. Firstly, energy is saved as the material does not need to be cooled down, granulated and reheated between the furnaces. Also, water and/or air and/or nitrogen used in the granulation is saved. Further, by enabling material to be fed in a liquid form between the furnaces, material, e.g. slag, can be withdrawn and fed continuously between the furnaces.

The feeding means (30) according to the first aspect may be located closer to the first end wall structure (27) in the first settler part (18) than to the middle of the settler (8).

It has been found that when molten material (31), and particularly slag, is fed to the settler (8) above the layer of slag (11) and in the first settler part (1), the slag is forced to move through the suspension coming from the reaction shaft (5). The reason being that the reaction shaft product is discharged from the furnace from the opposite side of the settler (8) compared to the feeding means (30). As a result, the molten material, e.g. slag, mixes with the reaction shaft output material, which contributes to the oxidation of the melt and creates a uniform mixture, and which has a positive effect on the yield of metals recovered from the process.

The inner space (9) of the settler (8) according to the first aspect may be in communication with the lower end of the reaction shaft (5) at a point of the settler (8) that is closer to the middle of the settler (8) than one of the ends of the settler (8).

The settler (8) according to the first aspect may have an elongated configuration. In one embodiment, the settler has the shape of a cuboid, wherein the cuboid rests on its base in a horizontal position. The settler may be 12 to 30 m long, 4 to 12 m wide and 1 to 3 m high.

The inventors have found that the configuration of the settler (8) has a number of advantages. For example, the first part of the settler (18) has a low dust content, since the gas and dust are sucked together with the off-gases through the gas phase of the second settler part (19) towards the uptake shaft (13). This lower dust content creates a relatively dust free atmosphere for the feeding means (30). This relatively dust free atmosphere is beneficial for minimising dust emissions from the furnace through the feeding means (30). Further, the first part of the settler (18) has a lower pressure than the second settler part (19), since gas and dust are sucked together with the off-gases through the gas phase of the second settler part (19) towards the uptake shaft (13). This lower pressure is beneficial for minimizing SO₂ emissions from the furnace through the feeding means (30).

The suspension smelting furnace may comprise a partition baffle for preventing oxidised dust created in the suspension smelting furnace from entering at least a section of the first settler part (18). The partition baffle may extend from the roof of the first settler part (18) downwards into the first settler part (18). The partition baffle may further minimise the dust content and lower the pressure in the first settler part (18).

In a traditional suspension smelting furnace, such as in a suspension smelting furnace as disclosed in the Finnish patent no. 22694, the end of the settler wall that is closer to the reaction shaft wears a lot, because of the closeness of the reaction shaft, which is the hottest part of the settler. In a suspension smelting furnace according to the invention, the end wall of the settler is located at a distance from this hottest part of the settler and thus wear will not be an issue.

In one embodiment, the suspension smelting furnace comprises reducing agent feeding means for feeding reducing agent(s) into at least one of the layers of matte or metal alloy and the layer of slag (10,11) in the first settler part (18). The first settler part (18) may also comprise a burner for creating a reducing atmosphere in at least a section of the first settler part (18). The burner may be used for creating a reducing atmosphere in at least a section of the first settler part (18), for example by consuming oxygen present in the first settler part (18) in the burning process. This further reduces the oxygen content in the first settler part (18).

The first settler part (18) according to the first aspect may have a first proximal end at the landing zone (7) and a first distal end at the opposite end of the first settler part (18) which first distal end also is the first end wall structure (27) of the settler (8), and wherein the feeding means (30) is arranged at the first distal end of the first settler part (18).

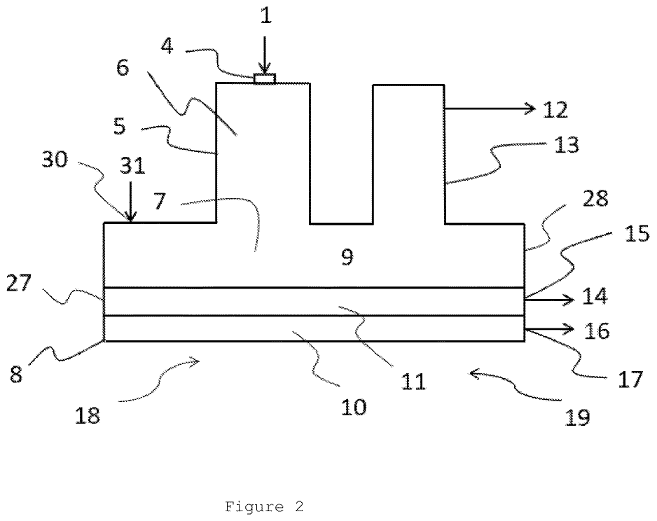

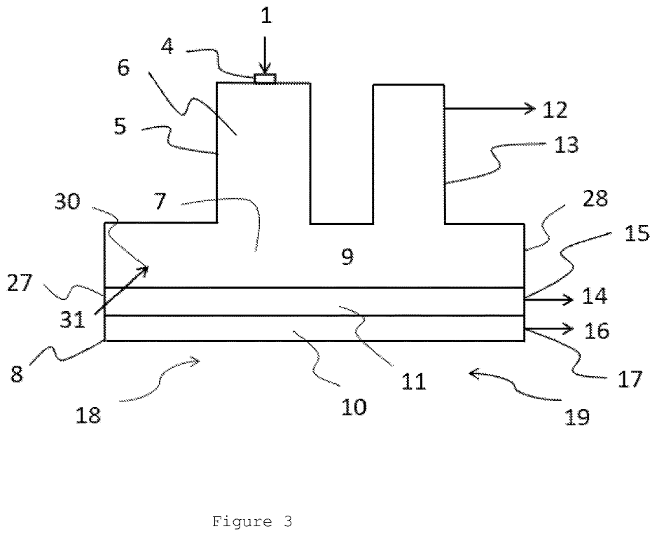

Alternatively, the feeding means (30) may be arranged in a side wall of the settler in the first settler part (18). This is illustrated in FIG. 3. Alternatively, the feeding means (30) may be arranged in the roof of the settler in the first settler part (18). This is illustrated in FIG. 2. The feeding means (30) may be at a distance of 0.2 to 2 m, or 0.4 to 1.8 m, or 0.6 to 1.6 m from the first end wall structure (27).

The feeding means (30) may comprise a launder for guiding the molten material extending from the end wall structure (27) or side wall or roof of the settler (8) into the inner space of the settler (9). The lauder can guide the molten material such that the molten material is not in direct contact with the end wall structure (27) or side wall or roof of the settler (8). In this way, the inner structure of the settler does not wear due to a constant contact with freshly introduced hot molten material.

The location of the feeding means (30) gives the advantage of maximising the distance between the inlet of the feeding means (30) and the reaction shaft (5), which gives the maximum possible contact time between the molten material and the product of the furnace. This is beneficial as the amount of material exchange between the molten material, especially slag, and the reaction shaft product in maximised.

The second settler part (19) according to the first aspect may have a second proximal end at the landing zone (7) and a second distal end at the opposite end of the second settler part (19) which second distal end also is the second end wall structure (28) of the settler (8), and wherein the first taphole (15) and the second taphole (17) are arranged at the second distal end of the second settler part (19).

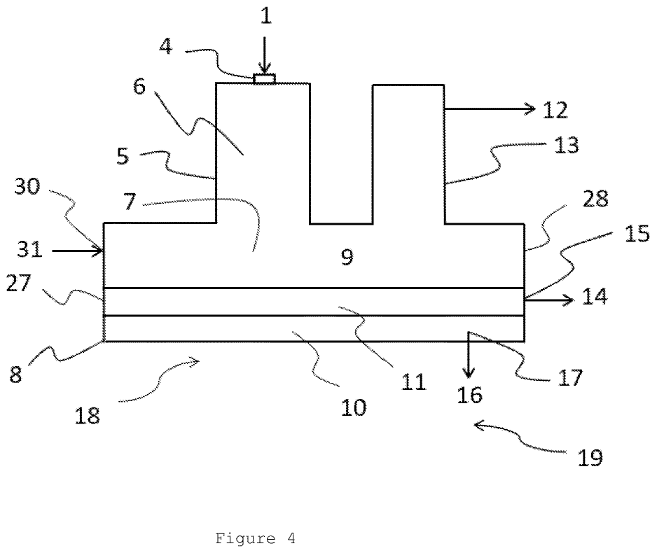

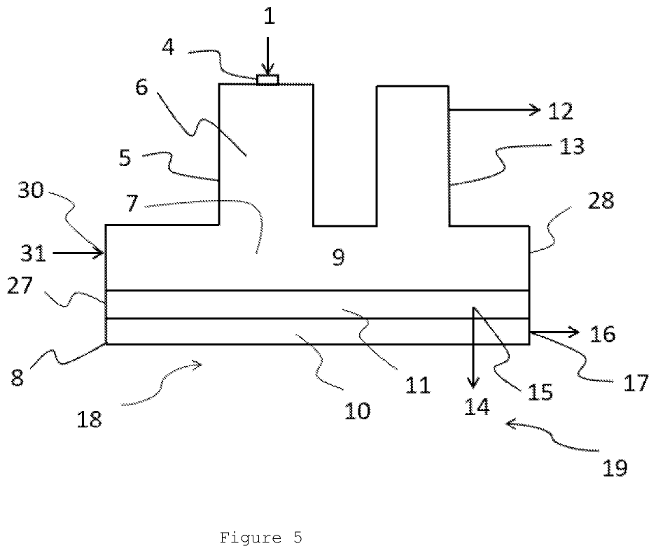

Alternatively, the first tap hole (15) may be arranged in the side wall of the settler (8) in the second settler part (19) and preferably at a distance of less than 2 m from the end wall (28). This is illustrated in FIG. 5. Alternatively, the second tap hole (17) may be arranged in the side wall of the settler (8) in the second settler part (19) and preferably at a distance of less than 2 m from the end wall (28). This is illustrated in FIG. 4. Both the first and second tap hole (15, 17) may be located in the sidewall or one of the first or second taphole (15, 17) may be located in the sidewall and one of the first or second taphole (15, 17) may be located in the end wall (28).

The location of the first and second tap holes (15, 17) gives the advantage of forcing the melt from the feeding means (30) to move through the reaction shaft output material before entering the tap hole.

The suspension smelting furnace according to the first aspect may comprise sucking means for leading process gases (12) from the suspension smelting furnace.

In one embodiment, the sucking means is a blower further down the process gas line.

### Method

The description related to the suspension smelting furnace above apply to the suspension smelting furnace in the description related to the method below.

According to a second aspect a method for producing matte or metal alloy in a suspension smelting furnace is provided, comprising:
i. feeding concentrate or matte (1) by means of a burner for burning concentrate or matte (4) into a reaction shaft (5) of the suspension smelting furnace to form a jet of an at least partially oxidised suspension (6) in the reaction shaft (5),
ii. receiving the jet of an at least partially oxidised suspension (6) in a landing zone (7) of a settler (8) in communication with a lower end of the reaction shaft (5), wherein the settler (8) has an inner space (9) and a first end wall structure (27) at one end of the settler (8) and a second end wall structure (28) at the opposite end of the settler (8), and wherein the settler (8) extends in two opposite directions from the landing zone (7) so that the settler (8) comprises a first settler part (18) on a first side of the landing zone (7) and a second settler part (19) on an opposite second side of the landing zone (7),
iii. forming a layer of matte or metal alloy (10) and a layer of slag (11) on top of the layer of matte or metal alloy (10) in the inner space (9) of the settler (8),
iv. discharging slag (14) from the layer of slag (11) in the settler (8) through a first taphole (15) arranged in the second settler part (19), and
v. discharging the matte or metal alloy (16) from the layer of matte or metal alloy (10) in the settler (8) through a second taphole (17) arranged in the second settler part (19), wherein the first taphole (15) is arranged in the vertical direction at a level above the second taphole (17), and wherein the method further comprises
vi. feeding a molten material (31) into the suspension smelting furnace through feeding means (30), wherein the feeding means (30) is in communication with the settler (8) in the first settler part (18) and the molten material (31) is fed to the first settler part (18) above the layer of slag (11).

If the suspension smelting furnace is an FSF, concentrate (1) may be fed to the burner (4) and if the suspension smelting furnace is an FCF, matte (1) may be fed to the burner (4). If the suspension smelting furnace is an FSF the method may comprise forming a layer of matte (10) under the layer of slag (11) and if the suspension smelting furnace is an FCF the method may comprise forming a layer of metal alloy (10) under the layer of slag (11). If the suspension smelting furnace is an FSF copper or nickel concentrate may be fed to the burner.

The method according to the second aspect may further comprise leading process gases (12) from the suspension smelting furnace via an uptake shaft (13) having a lower end in communication with the settler (8) in the second settler part (19).

The method according to the second aspect may further comprise feeding a fluxing agent (1), a reaction gas containing oxygen (1), solidified slag (1), dust (1) and/or material to be reverted (1) by means of the concentrate burner or a matte burner (4).

According to the second aspect, the matte may comprise copper matte and the metal alloy may comprise blister copper or the matte may comprise nickel matte.

The matte according to the second aspect may comprise copper or nickel matte, depending on if copper or nickel concentrate has been used. The metal alloy according to the second aspect may comprise blister copper.

The molten material (31) according to the second aspect may comprise slag, wherein the slag may comprise iron and copper oxides and fluxing agents, or wherein the slag may comprise iron and nickel oxides and fluxing agents.

The feeding means (30) according to the second aspect may be located closer to the first end wall structure (27) in the first settler part (18) than to the middle of the settler (8).

The molten material (31) according to the second aspect may be recycled from a second suspension smelting furnace or a Peirce Smith converter to the feeding means (30).

The molten material may be recycled from an FCF to an FSF if copper concentrate has been used or from a Peirce Smith converter to an FSF if nickel concentrate has been used. In one embodiment, matte is fed from the FSF to the FCF from which slag is recycled back to the FSF, if copper concentrate has been used. In one embodiment, matte is fed from the FSF to the Peirce Smith converter from which slag is recycled back to the FSF, if nickel concentrate has been used.

The inner space (9) of the settler (8) according to the second aspect may be in communication with the lower end of the reaction shaft (5) at a point of the settler (8) that is closer to the middle of the settler (8) than one of the ends of the settler (8).

The settler (8) according to the second aspect may have an elongated configuration.

The first settler part (18) according to the second aspect may have a first proximal end at the landing zone (7) and a first distal end at the opposite end of the first settler part (18), which first distal end also is the first end wall structure (27) of the settler (8), and wherein the feeding means (30) may be arranged at the first distal end of the first settler part (18).

The second settler part according to the second aspect may have a second proximal end at the landing zone (7) and a second distal end at the opposite end of the second settler part (18) which second distal end also is the second end wall structure (28) of the settler (8), and the first tap hole (15) and the second taphole (17) may be arranged at the second distal end of the second settler part (19).

The process gases (12) from the suspension smelting furnace according to the second aspect may be led via the uptake shaft (13) by sucking.

### EXAMPLES

The following example illustrates two processes where copper blister was produced in a process comprising an FSF and an FCF according to the invention. In the processes, copper concentrate was fed to the FSF where copper matte and slag was produced. Then the copper matte was fed to the FCF where copper blister and slag was produced. In process 1, no slag was recycled to the FSF from the FCF in a molten form. However, some slag was recycled from the FCF to the FSF in a solid form. In process 2, slag was recycled from the FCF to the FSF in a molten and some slag was recycled in a solid form.

The following streams were evaluated in the example.

TABLE 1
Definitions of the streams

| No | Stream | Particulars |
|---|---|---|
| 1 | FSF dryer feed mixture | the sum of concentrate mixture, silica flux, slag |
| | | concentrate and FCF slag fed to the FSF |
| 1a | Concentrate mixture | copper concentrate comprising copper, iron, sulphur, |
| | | gangue materials and impurity components |
| 1b | Silica flux | SiO2 as fluxing agent |
| 1c | Slag concentrate | copper oxide, iron silicate, iron magnetite, iron |
| | | oxide, sulfur, SiO2 and impurity components |
| 1d | FCF slag | copper oxide, iron oxide, calcium ferrite and |
| | | magnetite, SiO2 and CaO |
| 2 | FSF dryer steam | steam consumption in the FSF concentrate dryer |
| | consumption | |
| 3 | FSF technical oxygen | oxygen fed to the FSF |
| 4 | FSF natural gas | natural gas fed to the concentrate burner |
| 5 | FSF slag | copper oxide, iron silicate, iron magnetite, iron |
| | | oxide, sulfur, SiO2 and impurity components - slag |
| | | discharged from the FSF |
| 6 | FSF slag Fe:SiO2 | the weight ratio of Fe to SiO2 in the FSF slag |
| 7 | FSF matte | iron and copper sulphides - matte discharged from |
| | | the FSF |
| 8 | FSF matte Cu | copper % by weight of the FSF matte |
| 9 | FSF matte mill natural gas | natural gas consumption by the matte grinding mill |
| 10 | FSF WHB steam | steam generation in the FSF waste heat boiler |
| 11 | FSF ESP off gas | sulphur dioxide, carbon dioxide, water, nitrogen, |
| | | reaction shaft product - off gas fed to the FSF |
| | | electrostatic precipitator |
| 12 | FSF dust | copper and iron oxides - dust generated in the FSF |
| 13 | FCF matte | iron and copper sulphides - matte fed to the FCF |
| 14 | FCF lime | lime fed to the FCF as fluxing agent |
| 15 | FCF technical oxygen | oxygen fed to the FCF |
| 16 | FCF natural gas | natural gas fed to the FCF |
| 17 | FCF slag | copper oxide, iron oxide, calcium ferrite and |
| | | magnetite, SiO2 and CaO - slag discharged from |
| | | the FCF |
| 18 | FCF blister | blister copper, iron and sulphur - blister |
| | | discharged from the FCF |
| 19 | FCF slag granulation water | water consumption in the FCF slag granulation |
| 20 | FCF WHB steam | steam generation in the FCF waste heat boiler |
| 21 | FCF ESP off gas | sulfur dioxide, carbon dioxide, water, nitrogen, |
| | | reaction shaft product - off gas feed to the FCF |
| | | electrostatic precipitator |
| 22 | FCF dust | copper and iron oxides - dust generation in the FCF |

The particulars and results of the processes are illustrated in the table below.

TABLE 2
Particulars and results of the processes

| | | | | Difference | |
|---|---|---|---|---|---|
| | | Process | Process | (process 2 − | |
| No | Stream | 1 | 2 | process 1) | Unit |
| 1 | FSF dryer feed | 336.9 | 313.4 | −23.5 | t/h |
| | mixture | | | | |
| 1a | Concentrate | 265 | 265 | 0 | t/h |
| | mixture | | | | |
| 1b | Silica flux | 40.7 | 38.4 | −2.3 | t/h |
| 1c | Slag concentrate | 11.9 | 9.8 | −2.1 | t/h |
| 1d | FCF slag | 19 | 0 | −19 | t/h |
| 2 | FSF dryer steam | 50.8 | 47.3 | −3.6 | t/h |
| | consumption | | | | |
| 3 | FSF technical | 48190 | 44090 | −4100 | Nm3/h |
| | oxygen | | | | |
| 4 | FSF natural gas | 300 | 300 | 0 | Nm3/h |
| 5 | FSF slag | 201.5 | 198.2 | −3.3 | t/h |
| 6 | FSF slag Fe:SiO2 | 1.30 | 1.34 | 0.04 | — |
| 7 | FSF matte | 101.5 | 106.1 | 4.6 | t/h |
| 8 | FSF matte Cu | 69 | 67 | −2 | %- |
| | | | | | units |
| 9 | FSF matte mill | 810 | 850 | 40 | Nm3/h |
| | natural gas | | | | |
| 10 | FSF WHB steam | 76.2 | 82.5 | 6.3 | t/h |
| 11 | FSF ESP off gas | 88600 | 99900 | 11300 | Nm3/h |
| 12 | FSF dust | 23.5 | 21.7 | −1.8 | t/h |
| 13 | FCF matte | 101.5 | 106.1 | 4.6 | t/h |
| 14 | FCF lime | 3.6 | 4.6 | 1.0 | t/h |
| 15 | FCF technical | 17320 | 18310 | 990 | Nm3/h |
| | oxygen | | | | |
| 16 | FCF natural gas | 422 | 200 | −222 | Nm3/h |
| 17 | FCF slag | 19 | 25 | 5 | t/h |
| 18 | FCF blister | 68 | 68 | 0 | t/h |
| 19 | FCF slag | 3 | 0 | −3 | m3/h |
| | granulation water | | | | |
| 20 | FCF WHB steam | 29.6 | 30.3 | 0.7 | t/h |
| 21 | FCF ESP off gas | 31400 | 31800 | 400 | Nm3/h |
| 22 | FCF dust | 10.9 | 11.3 | 0.4 | t/h |

As seen in the above table, process 2 resulted in several OPEX savings. The most significant OPEX savings are listed in the table below.

TABLE 3
OPEX savings

| | percentage (%) of reduction |
|---|---|
| | in process 1 compared to |
| Reduced component | process 2 |
| Reduced FCF slag feed to the concentrate | −17.6 |
| burner - stream no. 1d | |
| Reduced FSF dryer feed - stream no. 1 | −7.0 |
| Reduced technical oxygen consumption in | −4.7 |
| FSF + FCF - stream no. 3 + 15 | |
| Reduced natural gas or oil consumption - | −25.2 |
| streams no. 4 + 9 + 16 | |
| Reduced dust amount - streams no 12 + 22 | −4.1 |
| Additional steam production - streams | 10.0 |
| no. 2 + 10 + 20 | |
| Reduced silica flux consumption - stream | −5.2 |
| no. 1b | |
| Increased lime flux consumption - stream | 27.8 |
| no. 14 | |

Additionally, the water consumption was reduced by about—3 m3/h in process 2 compared to process 1.

As such, process 2 resulted in several OPEX savings as well as in a reduced water consumption compared to process 1. This has a great positive effect on the environment as well as the economy.

1. A suspension smelting furnace, comprising:
i. a reaction shaft provided with a burner for burning concentrate or matte and feeding concentrate or matte into the reaction shaft to form a jet of an at least partially oxidised suspension in the reaction shaft,
ii. a settler in communication with a lower end of the reaction shaft, wherein the settler has an inner space and a first end wall structure at one end of the settler and a second end wall structure at the opposite end of the settler and a landing zone for the jet of oxidised suspension in the inner space of the settler below the lower end of the reaction shaft, and wherein the settler extends in two opposite directions from the landing zone so that the settler comprises a first settler part on a first side of the landing zone and a second settler part on an opposite second side of the landing zone, and wherein the settler is configured to receive the at least partially oxidised suspension from the reaction shaft at the landing zone and to form a layer of matte or metal alloy and a layer of slag on top of the layer of matte or metal alloy in the inner space of the settler,
iii. a first taphole arranged in the second settler part for discharging slag from the layer of slag in the inner space of the settler,
iv. a second taphole arranged in the second settler part for discharging matte or metal alloy from the layer of matte or metal alloy in the inner space of the settler, wherein the first taphole is arranged in the vertical direction at a level above the second taphole, and
v. feeding means for feeding a molten material to the suspension smelting furnace, wherein the feeding means is in communication with the settler in the first settler part above the layer of slag when in use.

2. The suspension smelting furnace according to claim 1, wherein the suspension smelting furnace further comprises an uptake shaft for leading process gases from the suspension smelting furnace via the uptake shaft, wherein the uptake shaft has a lower end in communication with the settler in the second settler part.

3. The suspension smelting furnace according to claim 1, wherein the burner further is suitable for feeding a fluxing agent, a reaction gas containing oxygen, solidified slag, dust and/or material to be reverted.

4. The suspension smelting furnace according to claim 1, wherein the matte comprises copper matte and the metal alloy comprises blister copper or wherein the matte comprises nickel matte.

5. The suspension smelting furnace according to claim 1, wherein the molten material comprises slag, preferably wherein the slag comprises iron and copper oxides and fluxing agents or wherein the slag comprises iron and nickel oxides and fluxing agents.

6. The suspension smelting furnace according to claim 1, wherein the feeding means is located closer to the first end wall structure in the first settler part than to the middle of the settler.

7. The suspension smelting furnace according to claim 1, wherein the inner space of the settler is in communication with the lower end of the reaction shaft at a point of the settler that is closer to the middle of the settler than one of the ends of the settler.

8. The suspension smelting furnace according to claim 1, wherein the settler has an elongated configuration.

9. The suspension smelting furnace according to claim 1, wherein the first settler part has a first proximal end at the landing zone and a first distal end at the opposite end of the first settler part which first distal end also is the first end wall structure of the settler, and wherein the feeding means is arranged at the first distal end of the first settler part.

10. The suspension smelting furnace according to claim 1, wherein the second settler part has a second proximal end at the landing zone and a second distal end at the opposite end of the second settler part which second distal end also is the second end wall structure of the settler, and wherein the first taphole and the second taphole are arranged at the second distal end of the second settler part.

11. The suspension smelting furnace according to claim 2, wherein the suspension smelting furnace comprises sucking means for leading process gases from the suspension smelting furnace.

12. A method for producing matte or metal alloy in a suspension smelting furnace, comprising:
i. feeding concentrate or matte by means of a burner for burning concentrate or matte into a reaction shaft of the suspension smelting furnace to form a jet of an at least partially oxidised suspension in the reaction shaft,
ii. receiving the jet of an at least partially oxidised suspension in a landing zone of a settler in communication with a lower end of the reaction shaft, wherein the settler has an inner space and a first end wall structure at one end of the settler and a second end wall structure at the opposite end of the settler, and wherein the settler extends in two opposite directions from the landing zone so that the settler comprises a first settler part on a first side of the landing zone and a second settler part on an opposite second side of the landing zone,
iii. forming a layer of matte or metal alloy and a layer of slag on top of the layer of matte or metal alloy in the inner space of the settler,
iv. discharging slag from the layer of slag in the settler through a first taphole arranged in the second settler part, and
v. discharging the matte or metal alloy from the layer of matte or metal alloy in the settler through a second taphole arranged in the second settler part, wherein the first taphole is arranged in the vertical direction at a level above the second taphole, and
vi. feeding a molten material into the suspension smelting furnace through feeding means, wherein the feeding means is in communication with the settler in the first settler part and the molten material is fed to the first settler part above the layer of slag.

13. The method according to claim 12, wherein the method further comprises leading process gases from the suspension smelting furnace via an uptake shaft having a lower end in communication with the settler in the second settler part.

14. The method according to claim 12, wherein the method further comprises feeding fluxing agents, a reaction gas containing oxygen and/or solidified slag, dust and/or material to be reverted by means of the concentrate burner or a matte burner.

15. The method according to claim 12, wherein the matte comprises copper matte and the metal alloy comprises blister copper or wherein the matte comprises nickel matte.

16. The method according to claim 12, wherein the molten material comprises slag, preferably wherein the slag comprises iron and copper oxides and fluxing agents or iron and nickel oxides and fluxing agents.

17. The method according to claim 12, wherein the feeding means is located closer to the first end wall structure in the first settler part than to the middle of the settler.

18. The method according to claim 12, wherein the molten material is recycled from a second suspension smelting furnace or a Peirce Smith converter to the feeding means.

19. The method according to claim 12, wherein the inner space of the settler is in communication with the lower end of the reaction shaft at a point of the settler that is closer to the middle of the settler than one of the ends of the settler.

20. The method according to claim 12, wherein the settler has an elongated configuration.

21. The method according to claim 12, wherein the first settler part has a first proximal end at the landing zone and a first distal end at the opposite end of the first settler part, which first distal end also is the first end wall structure of the settler, and wherein the feeding means is arranged at the first distal end of the first settler part.

22. The method according to claim 12, wherein the second settler part has a second proximal end at the landing zone and a second distal end at the opposite end of the second settler part which second distal end also is the second end wall structure of the settler, and the first tap hole and the second taphole is arranged at the second distal end of the second settler part.

23. The method according to claim 13, wherein the process gases from the suspension smelting furnace are led via the uptake shaft by sucking.
